(19) United States
(12) Patent Application Publication
(10) Pub. No.: US 2023/0113665 A1
(43) Pub. Date: Apr. 13, 2023

(54) SYSTEMS AND METHODS FOR MATERIAL DISPENSING CONTROL

(71) Applicant: Coherix, Ann Arbor, MI (US)

(72) Inventors: Douglas Davidson, Saline, MI (US); Benjamin Coffer, Dexter, MI (US)

(21) Appl. No.: 18/078,890

(22) Filed: Dec. 9, 2022

Related U.S. Application Data
(63) Continuation-in-part of application No. 17/409,621, filed on Aug. 23, 2021.

(51) Int. Cl. G05B 19/042; B05D 1/26; B05C 5/02

(52) U.S. Cl. CPC G05B 19/042; B05D 1/26; B05C 5/0225; G05B 2219/2601

(57) ABSTRACT

A method includes receiving a model of the material dispenser and, at a first characterization period of a material bead dispensing operation, communicating, to the material dispenser, a first characterization flow rate input. The method also includes, at a second characterization period of the material bead dispensing operation, communicating, to the material dispenser, a second characterization flow rate input. The method also includes generating, using at least one sensor, three-dimensional data associated with a material bead corresponding to the material bead dispensing operation. The method also includes characterizing at least one parameter of the model of the material dispenser using at least the first characterization flow rate input, the second characterization flow rate input, and the three-dimensional data associated with the material bead.

### CROSS-REFERENCES TO RELATED APPLICATIONS

This Continuation-In-Part patent application claims priority to U.S. patent application Ser. No. 17/409,621 filed Aug. 23, 2021, which is incorporated herein by reference in its entirety.

### TECHNICAL FIELD

This disclosure relates to material dispensing and in particular to systems and methods for material dispensing control.

### BACKGROUND OF THE INVENTION

Increasingly, various a manufacturing and/or assembly processes include the application of one or more materials to a surface of one or more components of an assembly. For example, in the automotive industry, components, such as windows, body panels, and the like, may be mated with and/or connected to other components of an automotive assembly. During assembly, one or more material beads (e.g., comprising such materials as adhesives, sealants, and the like) may be applied to one or more of the components. The component may be assembled, with the material bead providing adhesive features, sealing features, and/or other suitable material features.

During a material bead dispensing operation (e.g., which includes dispensing material to form a material bead on a corresponding component of an assembly), a robotic mechanism, such as a robotically controlled arm or other suitable robot or robotic mechanism, may cooperatively operate with a material dispenser to form the material bead on the component. For example, the robotic mechanism may receive program instructions which cause the robotic mechanism to traverse a defined path. An output of the material dispenser may be coupled or otherwise attached to the robotic mechanism or the robotic mechanism may be coupled or otherwise attached to the component, such that, as the robotic mechanism traverses the defined path, the output of the material dispenser also traverses the defined path or the dispenser remains substantially stationary while the robotic mechanism moves the component. The material dispenser may, according to a flow rate, dispense material along the defined path, forming the material bead.

### SUMMARY OF THE INVENTION

This disclosure relates generally to material dispensers.

An aspect of the disclosed embodiments includes a method for characterizing a material dispenser. The method includes receiving a model of the material dispenser and, at a first characterization period of a material bead dispensing operation, communicating, to the material dispenser, a first characterization flow rate input. The method also includes, at a second characterization period of the material bead dispensing operation, communicating, to the material dispenser, a second characterization flow rate input. The method also includes generating, using at least one sensor, three-dimensional data associated with a material bead corresponding to the material bead dispensing operation. The method also includes characterizing at least one parameter of the model of the material dispenser using at least the first characterization flow rate input, the second characterization flow rate input, and the three-dimensional data associated with the material bead.

Another aspect of the disclosed embodiments includes an apparatus for characterizing a material dispenser. The apparatus includes a processor and a memory. The memory includes instructions that, when executed by the processor, cause the processor to: receive a model of the material dispenser; at a first characterization period of a material bead dispensing operation, communicate, to the material dispenser, a first characterization flow rate input; at a second characterization period of the material bead dispensing operation, communicate, to the material dispenser, a second characterization flow rate input; generate, using at least one sensor, three-dimensional data associated with a material bead corresponding to the material bead dispensing operation; and characterize at least one parameter of the model of the material dispenser using at least the first characterization flow rate input, the second characterization flow rate input, and the three-dimensional data associated with the material bead.

Another aspect of the disclosed embodiments includes a system that includes a material dispenser configured to dispense a material bead. The system also includes a controlling mechanism configured to: receive a model of the material dispenser; at a first characterization period of a material bead dispensing operation, communicate, to the material dispenser, a first characterization flow rate input; at a second characterization period of the material bead dispensing operation, communicate, to the material dispenser, a second characterization flow rate input; generate, using a plurality of sensors, three-dimensional data associated with a material bead corresponding to the material bead dispensing operation; and characterize at least one parameter of the model of the material dispenser using at least the first characterization flow rate input, the second characterization flow rate input, and the three-dimensional data associated with the material bead.

An aspect of the disclosed embodiments includes a method for characterizing a material dispenser that dispenses a material in a material bead. The method includes receiving a model including at least one pre-pressure characteristic associated with the material dispenser. The method also includes calculating, using the pre-pressure characteristic, a pre-pressure value. The method also includes communicating the pre-pressure value to the material dispenser. The method also includes at the material dispenser, applying a pressure corresponding to the pre-pressure value to the material prior to applying the material bead. The method also includes applying the material bead using the material dispenser. The method also includes generating, using data received from at least one sensor associated with the material bead dispenser, dimensions associated with the material bead. The method also includes adjusting the pre-pressure characteristic based on the dimensions.

Another aspect of the disclosed embodiments includes a system that a system including a robotic mechanism for use with a material dispenser configured to dispense a material in a material bead. The system also includes a controlling device configured to: receive a model of the robotic mechanism; based on the model of the robotic mechanism, calculate a first robotic mechanism speed for a first period of a material bead dispensing operation; communicate the first robotic mechanism speed to the robotic mechanism for use in applying the material bead; generate, using at least one sensor, material bead dimensions associated with the material bead; update the model of the robotic mechanism based on the material bead dimensions; and update the first robotic mechanism speed based on the model of the robotic mechanism.

Another aspect of the disclosed embodiments includes an apparatus for controlling a material dispenser and a robotic mechanism for use with the material dispenser. The apparatus includes a processor. The apparatus also includes a memory including instructions that, when executed by the processor, cause the processor to: receive a model of the material dispenser; receive a model of the robotic mechanism; based on the model of the robotic mechanism, calculate a robotic mechanism speed for a first period of a material bead dispensing operation; based on the model of the material dispenser, calculate a pre-pressure value; communicating the pre-pressure value to the material dispenser for use in a material bead dispensing operation; communicating the robotic mechanism speed to the robotic mechanism for use in the material bead dispensing operation; generate, using at least one sensor, dimension data associated with a material bead corresponding to the material bead dispensing operation; updating, based on the dimension data, at least one of the model of the material dispenser and the model of the robotic mechanism; and updating at least one of the pre-pressure value based on the model of the dispenser and the robotic mechanism speed based on the model of the robotic mechanism.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a material dispensing system according to the principles of the present disclosure.

FIG. 2 generally illustrates a controlling device according to the principles of the present disclosure.

FIG. 3 generally illustrates a material bead according to the principles of the present disclosure.

FIG. 4 generally illustrates a material bead according to the principles of the present disclosure.

FIG. 5 generally illustrates a material bead according to the principles of the present disclosure.

FIG. 6 generally illustrates a model of principal dispenser according to the principles of the present disclosure.

FIG. 7 is a flow diagram generally illustrating a material dispenser characterization method according to the principles of the present disclosure.

FIG. 8 generally illustrates a material bead according to the principles of the present disclosure.

FIG. 9 is a graph of the speed of a material dispenser with respect to a component as a material bead is applied.

FIG. 10 generally illustrates a material bead according to the principles of the present disclosure.

FIG. 11 is a graph of an optimal speed of a material dispenser with respect to a component and an optimal flow rate of the material dispenser.

FIG. 12 is a graph of a speed of a material dispenser with respect to a component and a flow rate of the material dispenser.

FIG. 13 is a flow diagram generally illustrating a material dispenser characterization method according to the principles of the present disclosure.

FIG. 14 is a flow diagram generally illustrating a robotic mechanism speed characterization method according to the principles of the present disclosure.

FIG. 15 is a flow diagram generally illustrating a method of characterizing a robotic speed and a material dispenser according to the principles of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, increasingly, various manufacturing and/or assembly processes include the application of one or more materials to a surface of one or more components of an assembly. For example, in the automotive industry, components, such as windows, body panels, and the like, may be mated with and/or connected to other components of an automotive assembly. During assembly, one or more material beads (e.g., comprising such materials as adhesives, sealants, and the like) may be applied to one or more of the components. The component may be assembled, with the material bead providing adhesive features, sealing features, and/or other suitable material features.

During a material bead dispensing operation (e.g., which includes dispensing material to form a material bead on a corresponding component of an assembly), a robotic mechanism, such as a robotically controlled arm or other suitable robot or robotic mechanism, may cooperatively operate with a material dispenser to form the material bead on the component. For example, the robotic mechanism may receive program instructions, which cause the robotic mechanism to traverse a defined path. An output of the material dispenser may be coupled or otherwise attached to the robotic mechanism or the robotic mechanism may be coupled or otherwise attached to the component, such that, as the robotic mechanism traverses the defined path, the output of the material dispenser also traverses the defined path or the dispenser remains substantially stationary while the robotic mechanism moves the component. The material dispenser may, according to a flow rate, dispense material along the defined path, forming the material bead.

However, during such material dispensing operations, various characteristics of the material dispensing, the robotic mechanism, the material being dispensed, the ambient temperature of the system comprising the robotic mechanism and the material dispenser, the barometric pressure associated with the system, and the like, may affect the desired aspects of the material bead. For example, the material dispenser may dispense the material at a slight variance from the flow rate input (e.g., an input indicating a desired rate at which the material is dispensed, which may include a suitable signal or other suitable input), which may cause inaccuracies in the material bead.

Additionally, or alternatively, the material dispenser may respond to a flow rate input to maintain consistent material volume even as the robotic mechanism changes speed. However, the robotic mechanism may often accelerate and decelerate faster than a material dispenser can reasonably respond. Depending on the dispenser technology of the material dispenser, changes in temperature and humidity can cause significant changes in dispensed volume of the material, as can changes in material viscosity from the top to bottom of material barrels (e.g., containers configured to hold material ready to be dispensed by the material dispenser) and between material barrels.

Accordingly, systems and methods, such as those described herein, configured to control various aspects of the dispensing system comprising the robotic mechanism and the material dispenser, may be desirable. In some embodiments, the systems and methods described herein may be configured to provide material bead inspection and process control. The systems and methods described herein may be configured to use one or more (e.g., such as one, two, three, four, and so on) sensors (e.g., such as laser triangulation sensors, image capturing sensors or devices, and the like) that substantially completely surround the output of the material dispenser (e.g., which may be referred to herein as a dispense nozzle) to substantially continuously measure the material bead and component surface, regardless of travel direction. Additionally, or alternatively, the systems and methods described herein may be configured to use one or more laser triangulation sensors (e.g., or other suitable sensors) that trail a material bead as the material bead is being applied to the component (e.g., such as in scenarios where the material bead is a straight bead having little to no change in direction).

In some embodiments, the systems and methods described herein may be configured to maintain correct material bead volume, which may reduce or eliminate relatively lengthy trial-and-error setup processes. In some embodiments the systems and methods described herein may be configured to calculate a material volume at every point along the material bead one or more scans (e.g., using the one or more sensors) of the material bead.

The systems and methods described herein may be configured to, using a dynamical model of the dispensing system calculated during a characterization operation, combined with the actual sensed measurements over multiple scans, directly control the flow rate input to the material dispenser, anticipating when and by how much to change the flow rate input to achieve desired volume results.

In some embodiments, the systems and methods described herein may be configured to, receive desired material bead volume, from a human machine interface (HMI), at multiple locations of the material bead. For example, a user of the dispensing system may use the HMI to interact with the dispensing system. The user may select sections of the material bead and may specify material bead volume for each of the selected sections. The user may then run several part cycles to allow the dispensing system to automatically adapt the dispense process to maintain the correct volumes at the correct locations.

In some embodiments, the systems and methods described herein may be configured to characterize dynamics of the material dispenser without running part cycles (e.g., a special “part” cycle may be run that dispenses a “throw away” bead that is deliberately perturbed to reveal the dynamical behavior of the entire dispensing system). This may reduce or eliminate the need for an experienced dispensing expert to adjust aspects of the dispensing system in a time-consuming, trial-and-error fashion.

In some embodiments, the systems and methods described herein may be configured to provide straightforward dispenser characterization, which may be used to optimize overall performance of the dispensing system. The systems and methods described herein may be configured to substantially continuously fine tune the dynamical model of the material dispenser during production on the actual parts. The systems and methods described herein may be configured to provide a graphical user interface to visually adjust the material bead size along any section (e.g., or zone) of the material bead. The systems and methods described herein may be configured to maintain the material bead volume (e.g. including around relatively tight corners and over temperature and/or humidity variation).

In some embodiment, the systems and methods described herein may be configured to provide the flow rate input to the material dispenser via the robotic mechanism and/or via an external, digital to analog converter (e.g., such as an Ethernet-connected 0-10 volts direct current digital to analog converter or other suitable digital to analog converter).

In some embodiments, the systems and methods described herein may be configured to provide a series of flow rate inputs at different frequencies and ramp rates to the material dispenser. The systems and methods described herein may be configured to user feedback from the internal sensors of the material dispenser to create a dynamical model of the material dispenser characteristics.

The systems and methods described herein may be configured to control flow, pre-pressure, and other material dispenser specific parameters to enhance performance (e.g., by reducing or eliminating pooling at the beginning and end of the material bead and/or on stitches of the material bead). The systems and methods described herein may be configured to use a bi-directional communication channel to the material dispenser, which may allow the material dispenser to send control parameters to the controlling device.

In some embodiments, the systems and methods described herein may be configured to adapt to changes in material and dispensing equipment inherent in the dispensing process, which may reduce or eliminate system downtime. The systems and methods described herein may be configured to accommodate variation sources, such as temperature, material viscosity, process variation, and the like. The systems and methods described herein may be configured to operate the robotic mechanism at maximum practical speeds as variation is managed. The systems and methods described herein may be configured to accommodate new assembly programs (e.g., such as vehicle assembly programs and the like), which may require less equipment, reduced capital investment, constrained floor space, reduced labor, and the like.

In some embodiments, the systems and methods described herein may be configured to streamline production start-up. The systems and methods described herein may be configured to use an artificial intelligence engine configured to use a machine learning model after a period of non-use (e.g., such as a weekend, holiday, work stoppage, and the like) to ensure that quality material beads can be dispensed immediately upon work start-up. The systems and methods described herein may be configured to manage material and dispensing process variation using local software, which may reduce or eliminate significant shop floor intervention by robot programmers, maintenance personnel, operators, and the like.

In some embodiments, the systems and methods described herein may be configured to provide Variable bead control. For example, the user of the dispensing system may interact with the controlling device HMI to create desired bead dimensions per zone without the need of a robot programmer or maintenance personnel. The systems and methods described herein may be configured to substantially continuously monitor and dispense the specified material bead in the specified zones, optimizing material usage by producing quality beads and reducing or eliminating squeeze out.

The systems and methods described herein may be configured to reduce or eliminate “boil-out” issues (e.g., such as in paint shop or other suitable location) due to inconsistent material beads. The systems and methods described herein may be configured to reduce contamination in an e-coat tank, reducing painted surface defects. The systems and methods described herein may be configured to reduce or eliminate redundant secondary hem over sealing, which may result in significant labor and material cost savings.

In some embodiments, the systems and methods described herein may be configured to learn the dynamical behavior unique to the dispenser system using a corresponding machine learning model. The systems and methods described herein may be configured to use that knowledge to predictively control the behavior of the material dispenser. The systems and methods described herein may be configured to ensure a high quality material bead of the proper volume is actually dispensed in each zone on the component, while adapting to changes in material, environment and/or process.

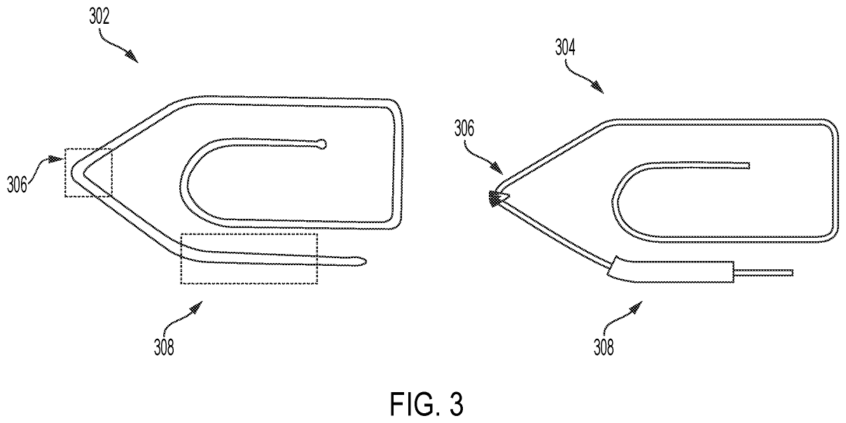

In some embodiments, the systems and methods described herein may be configured to generate new dispenser flow rate inputs for the next component based on previous component inspections. FIGS. 3-5 generally illustrate sample material beads and inspection thereof. As is generally illustrated, a material bead 302 may represent a best effort bead dispensed prior to characterization of various parameters of a model representing the material dispenser. A consistent 10 mm² bead diameter may be desired for the material bead 302.

However, the robotic mechanism speed may dictate the flow rate input, resulting to an inconsistent material bead volume, for example, at 306 and 308. The systems and methods described herein may be configured to generate the inspection image 304 indicating the inconsistent material bead volumes 306 and 308. The systems and methods described herein may be configured to use the controlling device, which uses various sensors, to analyze the material bead 302 and identify the inconsistent volumes 306 and 308.

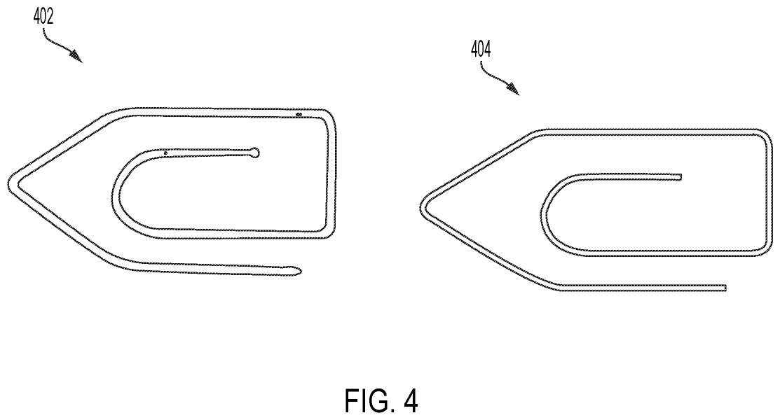

In some embodiments, the systems and methods described herein may be configured to characterize parameters of the model of the material dispenser, as described herein. In FIG. 4, a material bead 402 is generated using the characterized model of the material dispenser. For example, the controlling mechanism may generate the flow rate input based on a flow rate command using the characterized model. The systems and methods described herein may be configured to generate the image 404, which may indicate a positive inspection of the material bead 402.

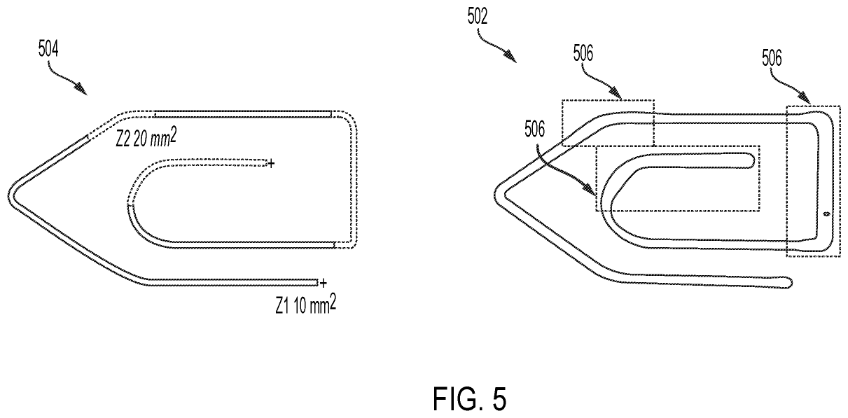

In some embodiments, as is generally illustrated in FIG. 5, the systems and methods described herein may be configured to use Customized material bead profiles in different zones. For example, the material bead 502 includes sections 506, which may correspond to sections selected by the user, using the HMI. The user may specify a volume size for the sections 506. The systems and methods described herein may be configured to provide the provided volume for each section 506 (e.g., which may be the same or different volumes). An inspection 504 may indicate that the sections 506 include the desired volumes.

In some embodiments, the systems and methods described herein may be configured to receive a model of the material dispenser. The systems and methods described herein may be configured to, at a first characterization period of a material bead dispensing operation, communicate, to the material dispenser, a first characterization flow rate input. The systems and methods described herein may be configured to, at a second characterization period of the material bead dispensing operation, communicate, to the material dispenser, a second characterization flow rate input.

The first characterization flow rate input and the second characterization flow rate input may correspond to a step function, wherein the first characterization flow rate input and second characterization flow rate input may include arbitrary values, and/or the first characterization flow rate input and the second characterization flow rate input may relate to one another in any suitable fashion or be unrelated to one another.

The systems and methods described herein may be configured to generate, using at least one sensor (e.g., such as at least one laser, at least one image capturing device, and the like), three-dimensional data associated with a material bead corresponding to the material bead dispensing operation. The systems and methods described herein may be configured to characterize at least one parameter of the model of the material dispenser using at least the first characterization flow rate input, the second characterization flow rate input, and the three-dimensional data associated with the material bead. The three-dimensional data may correspond to at least one portion of the material bead comprising a predefined pattern, such as a straight line, or other suitable pattern.

The systems and methods described herein may be configured to revise the model of the material dispenser by updating the at least one parameter of the model of the material dispenser. The systems and methods described herein may be configured to store the revised model of the material dispenser.

The systems and methods described herein may be configured to generate, in response to receiving a material dispense command, a material dispense flow rate input according to the revised model of the material dispenser. The systems and methods described herein may be configured to generate, using the at least one sensor, three-dimensional data associated with at least one other material bead corresponding to another material bead dispensing operation associated with the material dispense flow rate input.

In some embodiments, the systems and methods described herein may be configured to iteratively revise the model of the material dispenser using, at least, three-dimensional data, generated using the at least one sensor, associated with a plurality of other material beads corresponding to other material bead dispensing operations.

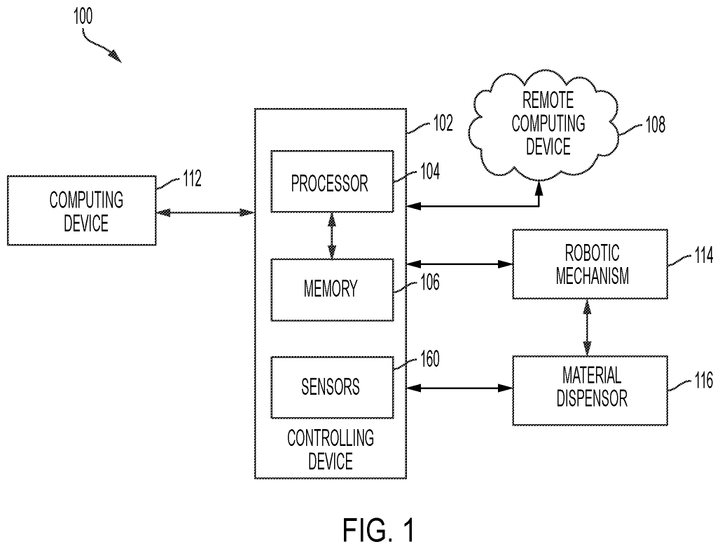

With reference to FIG. 1, a material dispensing system 100 according to the principles of the present disclosure, is generally illustrated. The system 100 may include a controlling device 102. The controlling device 102 may include a processor 104 and a memory 106. The processor 104 may include any suitable processor, such as those described herein. Additionally, or alternatively, the controlling device 102 may include any suitable number of processors, in addition to or other than the processor 104.

The memory 106 may comprise a single disk or a plurality of disks (e.g., hard drives), and includes a storage management module that manages one or more partitions within the memory 106. In some embodiments, memory 106 may include flash memory, semiconductor (solid state) memory or the like. The memory 106 may include Random Access Memory (RAM), a Read-Only Memory (ROM), or a combination thereof. The memory 106 may include instructions that, when executed by the processor 104, cause the processor 104 to, at least, perform the functions associated with the systems and methods described herein.

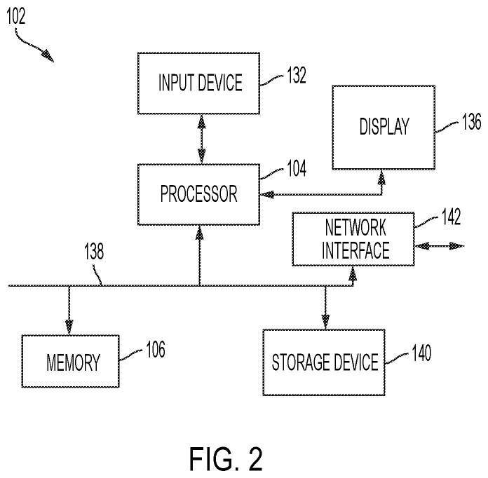

The controlling device 102 may include or be in communication with a user input device 132, as is generally illustrated in FIG. 2, which may be configured to receive input from a user of the controlling device 102 and to communicate signals representing the input received from the user to the processor 104. For example, the user input device 132 may include a button, keypad, dial, touch screen, audio input interface, visual/image capture input interface, input in the form of sensor data, etc.

In some embodiments, the user input device 132 may be associated with a computing device 112 of the system 100. The computing device 112 may be associated with user of the system 100. The computing device 112 may include any suitable computing device including a mobile computing device (e.g., a smart phone, tablet, or other suitable mobile computing device), a laptop-computing device, a desktop computing device, or any other suitable computing device. The computing device 112 may be used by the user to communicate and/or interact with the controlling device 102 or other suitable aspects of the system 100. The computing device 112 may be proximately located to the controlling device 102 or remotely located from the controlling device 102.

The controlling device 102 may include or be in communication with, via the computing device 112, a display 136 that may be controlled by the processor 104 and/or the computing device 112 to display information to the user. A data bus 138 may be configured to facilitate data transfer between, at least, a storage device 140 and the processor 104. The controlling device 102 may also include a network interface 142 configured to couple or connect the controlling device 102 to various other computing devices or network devices via a network connection, such as a wired or wireless connection, or other suitable connection. In some embodiments, the network interface 142 includes a wireless transceiver or other suitable mechanism.

The storage device 140 may comprise a single disk or a plurality of disks (e.g., hard drives), one or more solid-state drives, one or more hybrid hard drives, and the like. The storage device 140 may include a storage management module that manages one or more partitions within the storage device 140. In some embodiments, storage device 140 may include flash memory, semiconductor (solid state) memory or the like. In some embodiments, the storage device 140 may be remotely located from the controlling device 102, such as on the computing device 112, on a remotely located computing device, a database, a data center, or other suitable location.

The controlling device 102 may communicate with a remote computing device 108. The remote computing device 108 may include any suitable computing device or devices, such as a cloud computing device or system, a remotely located server or servers, a remotely or proximately located mobile computing device or application server that provides information to a mobile computing device, other suitable remote computing devices, or a combination thereof. The remote computing device 108 may be remotely located from the controlling device 102, such as in a datacenter or other suitable location.

In some embodiments, the controlling device 102 receives a model of a material dispenser 116. For example, the controlling device 102 may receive the model from the remote computing device 108, the computing device 112, or other suitable location. The material dispenser 116 may include any suitable material dispenser configured to dispense material beads onto an assembly component, as described. The controlling device may, selectively control the material dispenser 116 and/or a robotic mechanism 114 to perform a material bead dispensing operation. The robotic mechanism 114 may include any suitable robot configured to traverse a predefined path (e.g., following a program), with the output (e.g., dispensing nozzle) of the material dispenser 116 (e.g., while the output of the material dispenser 116 is coupled or otherwise attached to the robotic mechanism 114). The robotic mechanism 114 may move the dispensing nozzle, which may be connected by a flexible hose to a stationary dispensing station which houses the pumps, meters, and control electronics of the material dispenser 116. Additionally, or alternatively, the robotic mechanism 114 may be configured to be coupled, attached to, or otherwise engaged with the component. The robotic mechanism 114 may move the component according to the program while the material dispenser 116 remains stationary or substantially stationary. The material dispenser 116 may dispense material onto the component as the robotic mechanism 114 moves the component.

In some embodiments, the material dispenser 116 may be a material dispenser gun and may include a dispenser valve which may be electrically, pneumatically, or otherwise operated. In some embodiments, the dispenser valve may be configured to be either completely open or completely closed. In some embodiments, the dispenser valve may include, or may be mounted serially with, a flow control valve. The flow control valve may be configured to be opened partially, for example as a percentage of fully open. The material dispenser 116 may be in an open state that may include a valve being completely or partially open, or a closed state, in which the valve is completely closed. As the dispenser valve transitions from a closed state to an open state, the material may flow out of the dispenser nozzle.

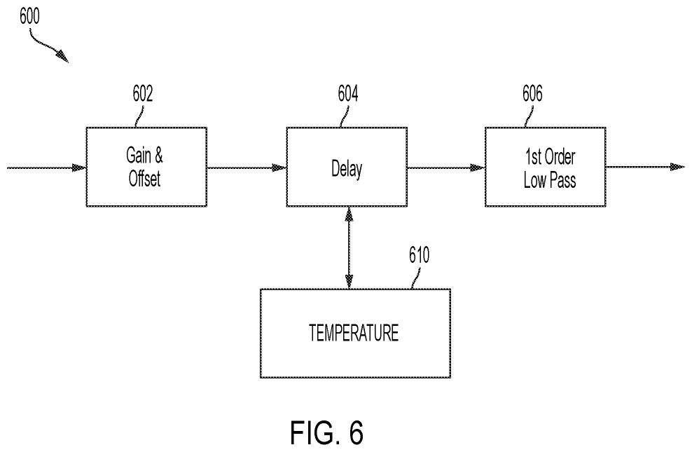

The model of the material dispensing 116 may include any suitable model, such a model 600 as is generally illustrated in FIG. 6. The model 600 may be configured to mathematically represent parameters of the material dispenser 116. For example, the model 600 may include a gain and offset parameter 602, a delay parameter 604, and a first order low pass parameter 606. In some embodiments, the model 600 may include a temperature parameter 610, which may represent ambient temperature associated with the material dispenser 116 or the system 100. It should be understood that the model 600 may include any suitable parameters in addition to or instead of those described herein, such as a barometric pressure parameter, and the like.

The controlling device 102 may, at a first characterization period (e.g., which may include a start of the material bead dispensing operation) of the material bead dispensing operation, communicate, to the material dispenser 116, a first characterization flow rate input. The controlling device 102 may, at a second characterization period (e.g., which may include a period following the first period) of the material bead dispensing operation, communicate, to the material dispenser 116, a second characterization flow rate input. It should be understood that the first period and the second period may include any suitable periods and may be of any suitable length. The first characterization flow rate input and the second characterization flow rate input may correspond to a step function, the first characterization flow rate input and second characterization flow rate input may include arbitrary values, and/or the first characterization flow rate input and the second characterization flow rate input may relate to one another in any suitable fashion or be unrelated to one another.

The controlling device 102 may be configured to characterize at least one parameter of the model 600. For example, the controlling device 102 may generate, using various sensors 160, three-dimensional data associated with a material bead corresponding to the material bead dispensing operation. The various sensors may include one or more triangulation lasers, one or more image capturing devices, one or more other suitable sensors, or a combination thereof.

The controlling device 102 may characterize at least one parameter of the model 600 of using at least the first characterization flow rate input, the second characterization flow rate input, and the three-dimensional data associated with the material bead. For example, the controlling device 102 may analyze, using the three-dimensional data, aspects of the material bead corresponding to the first flow rate input and aspects of the material bead corresponding to the second flow rate input.

The controlling device 102 may compare expected material bead volumes corresponding to the first flow rate input with actual material bead volumes corresponding to the first flow rate input, compare expected material bead volumes corresponding to the second flow rate input with actual material bead volumes corresponding to the second flow rate input, and/or compare an expected shaped of the material bead with the actual shape of the material bead. The controlling device 102 may determine variances between the expected aspects of the material bead and the actual aspects of the material bead. The controlling device 102 may characterize at least one of the gain and offset parameter 602, the delay parameter 604, and the first order low pass parameter 606 based on the variances.

In some embodiments, the controlling device 102 may be configured to calculate an inverse for each parameter of the model 600. For example, the controlling device 102 may, using a desired flow rate command, calculate an inverse for each parameter of the model 600. The controlling device 102 may use the inverse of each parameter of the model 600 to determine a flow rate input, which, when applied to the material dispenser 116, generates a material bead corresponding to the flow rate command. The controlling device 102 may characterize at least one parameter of the model 600 based on a comparison of the flow rate command, the flow rate input, and three-dimensional data corresponding to the material bead.

In some embodiments, the controlling device 102 may be configured to control the material dispenser to dispense a straight line bead according to a first flow rate input and, substantially half way through the dispensing of the material bead, increase the first flow rate input according to a step function. The controlling device 102 may characterize the at least one parameter of the model 600 based on three-dimensional data corresponding to the change in material output associated with the increase in flow rate input. Additionally, or alternatively, the controlling device 102 may use arbitrary, known, flow rate inputs during dispensing of the material bead. The controlling device 102 may characterize the at least one parameter based on three-dimensional data corresponding to material bead associated with the arbitrary flow rate inputs.

In some embodiments, the controlling device 102 may selectively control the material dispenser 116 to dispense material, according to a flow rate input, into a container, such as a bucket or other suitable container. The controlling device 102 may receive, from various sensors associated with the material dispenser 116 (e.g., internal sensors or proximate sensors of the material dispenser 116), material output measurements indicating actual material output of the material dispenser 116. The controlling device 102 may characterize the at least one parameter of the model 600 based on a comparison between the flow rate input and the actual material output received from the sensors of the material dispenser 116.

In some embodiments, the container may be disposed on a scale. The controlling device 102 may receive, from the scale, a measurement corresponding to a weight of the material dispensed by the material dispenser 116. The controlling device 102 may determine an expected weight of the material to be dispensed according to the flow rate input. The controlling device 102 may characterize the at least one parameter of the model 600 based on the flow rate input, the expected weight of the material, the actual weight of the material, and/or the material output provided by the sensors of the material dispenser 116. Additionally, or alternatively, the controlling device 102 may vary the flow rate of the material dispenser 116 by providing varied flow rate inputs. The controlling device 102 may characterize the at least one parameter of the model 600 based on the varied flow rate inputs and corresponding weights of the material dispensed in response to each flow rate input (e.g., based on the varied flow rate inputs, the expected weights for each flow rate input, the actual weights of the material, and/or the material output provided by the sensors of the material dispenser 116).

In some embodiments, the controlling device 102 may locally adjust aspects of the material bead based on measurements of each material bead dispensed by the material dispenser 116. For example, the controlling device 102 may analyze, using three-dimensional data, a material bead after the material bead is dispensed by the material dispenser 116. The controlling device 102 may identify inconsistent areas of the material bead (e.g., which may include areas of the material bead having volumes that are inconsistent with desired volumes of the material bead). The controlling device 102 may selectively adjust the flow rate input on subsequent dispenses of similar material beads to address the inconsistent areas of the material bead (e.g., by increase and/or decreasing the flow rate input at the inconsistent areas of the material bead).

The controlling device 102 may revise the model 600 by updating the at least one parameter of the model 600. The controlling device 102 may store the revised model 600 in memory, such as in the memory 106 or other suitable location. The controlling device 102 may generate, in response to receiving a material dispense command, a material dispense flow rate input according to the revised model 600. The controlling device 102 may generate, using the sensors 160, three-dimensional data associated with at least one other material bead corresponding to another material bead dispensing operation associated with the material dispense flow rate input.

In some embodiments, the controlling device 102 may iteratively revise the model 600 using, at least, three-dimensional data, generated the sensors 160, associated with a plurality of other material beads corresponding to other material bead dispensing operations.

In some embodiments, as described, the model 600 may include the temperature parameter 610. The controlling device 102 may be configured to capture an ambient temperature associated period of characterization of the other parameters of the model 600. The controlling device 102 may store the captured temperature as the temperature parameter 610 with the other parameters of the model 600.

For example, the other parameters of the model 600 may vary with changes in temperature, may vary at specific absolute temperatures, and the like. The controlling device 102 may, in response to receiving a flow rate command, determine an ambient temperature of the system 100. The controlling device 102 may identify parameters of the model 600 corresponding to the temperature (e.g., the parameters may be stored according to a range of temperatures, according to a variation in a previous temperature and a current temperature, according to an absolute temperate, and the like). The controlling device 102 may revise the model 600 according to the identified parameters (e.g., corresponding to the temperature). The controlling device 102 may generate the flow rate input based on the revised model 600.

In some embodiments, the controlling device 102 may be configured to determine, using a flow rate input and an expected pre-pressure, pre-pressure characteristics of the material dispenser 116. The pre-pressure characteristics may indicate a rate at which the pre-pressure of the material dispenser builds up prior to dispensing material. The controlling device 102 may selectively adjust parameters of the model 600 based on analyzing the actual pre-pressure characteristics with the expected pre-pressure characteristics. The controlling device 102 may selectively control pre-pressure characteristics of the material dispenser 116 by adjusting the flow rate input accordingly.

The pre-pressure characteristics may include a pre-pressure value which is the target pressure to be built up in the material dispenser 116 prior to dispensing the material. The pre-pressure characteristics may also include the rate at which pressure is built up or a rate of pressurization. The rate of pressurization may be a parameter provided by the manufacturer of the material dispenser 116 and may be characterized by the time it takes the system to reach a steady-state pressure after the nozzle is closed. The rate of pressurization parameter may be represented by a time constant (e.g., the time it takes the system to achieve 63.2% of its final value) after the nozzle of the material dispenser is closed. For a given set of pre-pressure characteristics, the resulting material bead may be measured to determine the resulting material bead dimensions from the pre-pressure characteristics. The resulting initial flow rate may also be determined from the pre-pressure characteristics. The controlling device 102 may calculate a desired pre-pressure value from the pre-pressure characteristics and communicate the pre-pressure value to the material dispenser 116. The material dispenser 116 may pressurize the material to the pre-pressure value prior to the bead dispensing operation.

Pre-pressure control may be used to achieve correct material bead dimensions, volumes, or both when a material dispenser 116 transitions from a closed state to an open state. In response to the material dispenser 116 being in the open state, the material dispenser 116 may maintain the material flow rate at a value as described herein. Additionally, or alternatively, the initial material flow rate may be substantially determined by the pre-pressure in response to the value transitioning from a closed state to an open state. If the pre-pressure is high, then excess material may exit the nozzle when the dispenser valve is open, causing the initial material bead dimensions or volume to be too large. Conversely, if the pre-pressure is low, then the material may flow slowly (or “ooze”) out of the nozzle when the dispenser valve is open, causing the initial material bead dimensions or volume to be too small. After the material has been flowing for a period, typically tens or hundreds of milliseconds, the flow rate will return to a steady state, producing a material bead of dimensions corresponding to steady state operation that substantially corresponds to a flow rate command provided to the material dispenser 116 by the controlling device 102. An additional parameter may be used to characterize the amount of time (or time constant) for the system to reach a steady state after the nozzle of the material dispenser is open. The material dispenser 116 may, in response to receiving the pre-pressure value from the controlling device 102, raise or lower the pressure on the material to the pre-pressure value prior to opening the dispenser valve.

In some embodiments, an operator of the dispensing system may inspect an initial bead after opening the dispenser valve. If the bead is too large, the operator may decrease the dispenser pre-pressure. If the initial bead was too small, the operator may increase the pre-pressure. In some environments, this inspection may be performed frequently, such as daily or several times a week. This process may be automated using pre-pressure characterization or pre-pressure modelling, which includes having the controlling unit 102 identify a relationship between the pre-pressure and initial bead size. In some embodiments, pre-pressure characterization or modelling may be accomplished by having the material dispenser 116 dispense a plurality of test beads (e.g., five beads, though more or fewer are contemplated) while the controlling device 102 varies the pre-pressure value and measures the initial bead of each test bead using sensors 160 of the dispensing system, such as laser triangulation sensors, image capturing sensors, or both. Using a plurality of test beads to assess the pre-pressure characteristics and build the pre-pressure model may mostly or completely avoid manual trial-and-error pre-pressure tuning. The pre-pressure model or pre-pressure parameters may be included in the model 600 of the material dispensing device.

In response to the pre-pressure characteristics being determined and the pre-pressure model being received or calculated, the controlling device 102 may calculate an optimal pre-pressure value which yields a desired initial bead size. The controlling device 102 may send these values to the material dispenser 116 prior to or during the dispense process.

During production, the controlling device 102 may continuously monitor the dimensions of the initial bead size of each material bead and update the pre-pressure characteristics and pre-pressure model. If, during production, the initial dimensions of a bead are detected as being too small, the controlling device 102 may increase the pre-pressure for the corresponding bead in a subsequent component. If the initial dimensions are detected as being too large, the controlling device 102 may decrease the pre-pressure for that bead on a subsequent component. This may mostly or completely avoid manual pre-pressure adjustments by an operator.

In some embodiments, a material bead volume may be measured by various sensors which measure three-dimensional data associated with a material bead corresponding to a material bead dispensing operation. The three-dimensional data may be used to calculate a material bead volume, the dimensions of the material bead, or both. The dimensions of the material bead may include a bead width and a bead height, as well as properties indicating the shape of the bead. For example, the bead volume may be approximated by a horizontal cylindrical segment, a triangle, or other shape. In some embodiments, the systems and methods described herein may be configured to maintain correct material bead dimensions, volumes, or both, and the systems and methods may receive a material bead dimension, volume, or both.

In some embodiments, the controlling device 102 may be configured to characterize a model of the robotic mechanism 114. The model of the robotic mechanism 114 may include features similar to or different from the model 600. The controlling device 102 may characterize parameters of the model of the robotic mechanism 114, as described.

The controlling device 102 may selectively control the speed of the robotic mechanism 114 based on the model of the robotic mechanism 114. For example, the robotic mechanism 114 may traverse a predefined path along the component. The controlling device 102 may increase and/or decrease the speed of the robotic mechanism 114 at identified areas of the path based on the characterized model of the robotic mechanism 114.

In some embodiments, the controlling device 102 may overdrive (e.g., in a positive direction or a negative direction) the material dispenser 116. For example, the controlling device 102 may determine, based on the model 600, that the material dispenser 116 may not be capable, given a time constraint, to deliver a flow rate corresponding to flow rate command. The controlling device 102 may overdrive (e.g., increase or decrease flow rate to a maximum or minimum limit) to achieve the flow rate corresponding to the flow rate command.

In some embodiments, the controlling device 102 may be configured to reduce, minimize, or eliminate an error between a desired material bead volume and an actual material bead volume. For example, the controlling device 102 may adjust the flow rate inputs provided to the material dispenser 116, as described. Additionally, or alternatively, the controlling device 102 may selectively adjust a speed of the robotic mechanism 114 to further reduce, minimize, or eliminate the error between the desired material bead volume and the actual material bead volume. For example, the controlling device 102 may selectively decrease the speed of the robotic mechanism 114 in an area on the component where the material dispenser 116 is unable to maintain the desired flow rate and/or increase the speed of the robotic mechanism 114 where the material dispenser 116 is able to dispense the material bead at a higher rate than the desired flow rate.

In some embodiments, the controlling device 102 controls the speed of the robotic mechanism 114 to maintain desired material bead dimensions, volume, or both. The controlling device 102 controls the speed of the robotic mechanism 114 which determines the speed of the material dispenser 116 relative to a component. This may be in some embodiments where a robotic mechanism 114 moves the dispenser nozzle with respect to the component or in embodiments where the component is moved with respect to the dispenser. A user interface or HMI may be used to enter one or more desired bead dimensions for various segments of a bead to specify the volume, dimensions, or both of each bead segment. During the dispensing process, the cross-sectional area of the bead is determined by both the dispenser speed with respect to the component and the flow rate of the bead by the formula:

$$Cross Sectional Area [ {mm}^{2} ] = \frac{Flow Rate [ {mm}^{3} / sec ]}{Speed [ mm / sec ]}$$

The controlling device 102 may determine the desired cross section of the bead, as well as volume and dimensions of the bead, by controlling the speed of the robotic mechanism 114 and the flow rate of the dispenser.

In some embodiments, the flow rate of the material dispenser 116 may be constant during a bead dispensing operation, for example when a controlling device 102 sets the flow rate of the dispenser between bead dispensing processes. In such embodiments, the specified value of the flow rate is not substantially changed during the bead dispensing process. The controlling unit may calculate an optimal constant flow rate value and optimal speed values for the dispenser. These calculations are based on the physical constraints of the material dispenser 116 and robotic mechanism 114, such as the maximum usable flow rate of the dispenser and maximum usable speed of the robot.

These physical constraints may be included in the model of the robotic mechanism 114, which may include features similar to or different from the model 600. The maximum usable flow rate or maximum usable speed may not be the actual maximum flow rate or maximum speed because of constraints when operating near the limits of the robotic mechanism 114 and material dispenser 116. For example, the dispenser flow may be more variable at high flow rates, limiting the flow rate to a lower value when variability is not desired. Similarly, the maximum speed of the robotic mechanism 114 may be limited when the robotic mechanism 114 must form a curved bead, as opposed to in a straight line. For simplicity, maximum flow rate and maximum speed will be used, though those skilled in the art would understand that maximum usable or effective usable flow rate or speed may be the actual maximum.

In some embodiments, the flow rate may be changed during the bead dispensing operation, for example by sending a flow rate to the dispensing mechanism at regular intervals (e.g., every 10 ms), by updating the value of the flow rate during the dispensing process, or by sending a series of flow rates and times to update the dispensing value prior to beginning the dispensing operation.

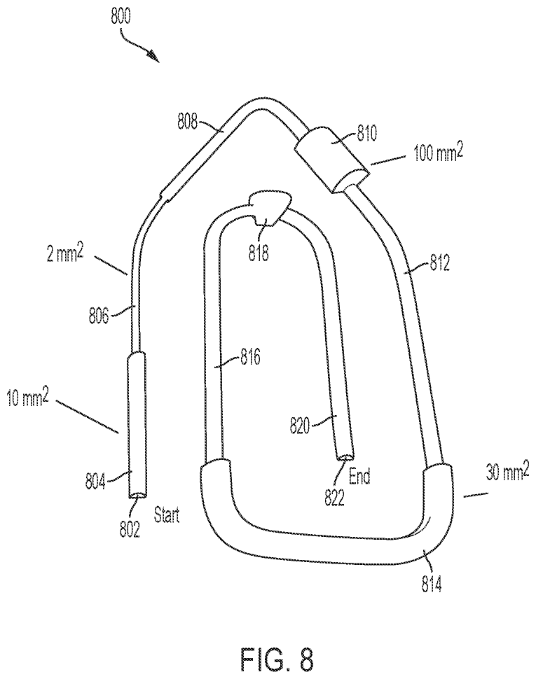

FIG. 8 illustrates a sample bead 800. As illustrated, the bead has different desired dimensions in different segments. Bead 800 starts at start point 802 with segment 804 having a desired cross sectional area of 10 mm². Segment 804 is then followed by segments with varying cross sectional areas: 806 (2 mm²), 808 (10 mm²), 810 (100 mm²), 812 (10 mm²), 814 (30 mm²), 816 (10 mm²), 818 (100 mm²), and 820 (10 mm²). Bead 800 ends at end point 822. In sample bead 800, the thinnest segment is segment 806 at 2 mm². Segments 810 and 818 are the thickest, at 100 mm². To minimize the amount of time to lay the bead, it is advantageous to use the highest flow rate of which the dispenser is capable, but this may not be possible if the robot cannot move the material dispenser 116 fast enough to lay the thinnest (in this example, 2 mm²) at the material dispenser's maximum flow rate. For purposes of this example, the robotic mechanism 114 may have a maximum speed of 400 mm/sec, but the maximum usable speed may be 200 mm/sec due to the shape of the bead or speed required for adjacent segments.

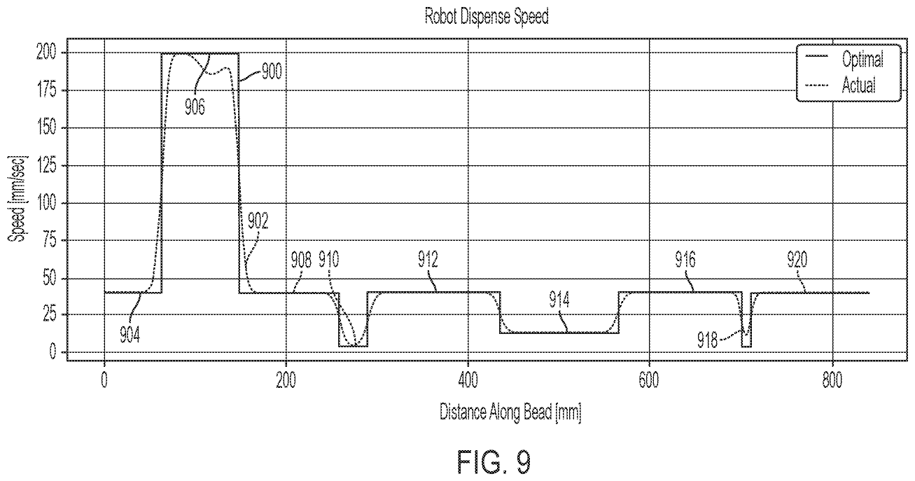

The maximum speed may be included in the model of the robotic mechanism 114. Because the maximum speed of the robot is 200 mm/sec, and the desired bead cross sectional area in the thinnest segment is 2 mm², the maximum flow rate is 400 mm³, applying the formula above, in embodiments where the flow rate during a bead is constant. Given the maximum flow rate of 400 mm³, the ideal dispenser speed may be calculated for each segment, shown in FIG. 9 in solid line 900, where the sections correspond to those of FIG. 8 as follows: 904 corresponds to 804, 906 corresponds to 806, 910 corresponds to 810, 912 corresponds to 812, 914 corresponds to 814, 916 corresponds to 816, 918 corresponds to 818, and 820 corresponds to 920. In embodiments with constant flow rates, the flow rate is sent to the dispenser prior to the dispense process which it is for.

The speed of the robot for the individual segments may be sent to the robot in many ways. For example, the controlling device 102 may generate the optimal speeds and upload the speeds to the robotic mechanism 114 prior to the robotic mechanism 114 dispensing the bead. The optimal speeds may be used to update an existing program in the robotic mechanism 114 for dispensing the bead. The controlling device 102 may send real-time speed values to the robotic mechanism 114 at regular intervals (e.g., every 10 milliseconds) during the dispensing process. The speed values may be in mm/sec or may be as a percentage of the robot's programmed speed or maximum (actual or effective) speed. In some embodiments, the controlling device 102 may send real-time motion commands, including speed but also including direction, to the robotic mechanism 114 at regular intervals (e.g., every 10 milliseconds) during the dispense process. The robotic commands may be sent using open or proprietary protocols for communicating with the robot.

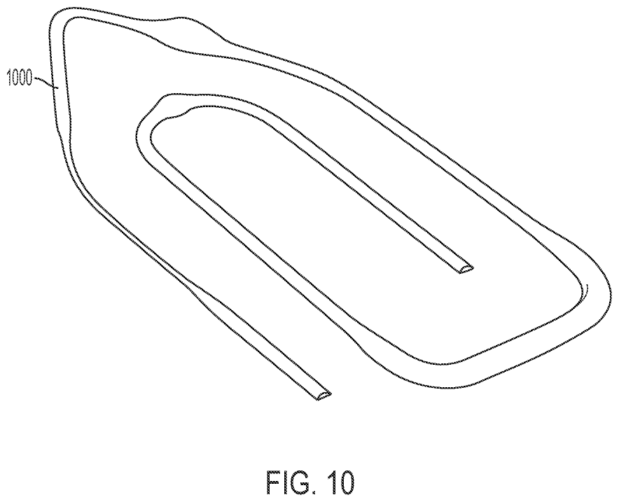

As shown in FIG. 9, the robotic mechanism 114 may attempt to maintain the optimal speeds, but actual speed, shown in dashed line 902, of the robotic mechanism 114 may deviate from the optimal. In the example, the dispense process may take approximately 29 seconds, resulting in bead 1000 shown in FIG. 10. The deviations from optimal may be used to update the model of the robotic mechanism 114.

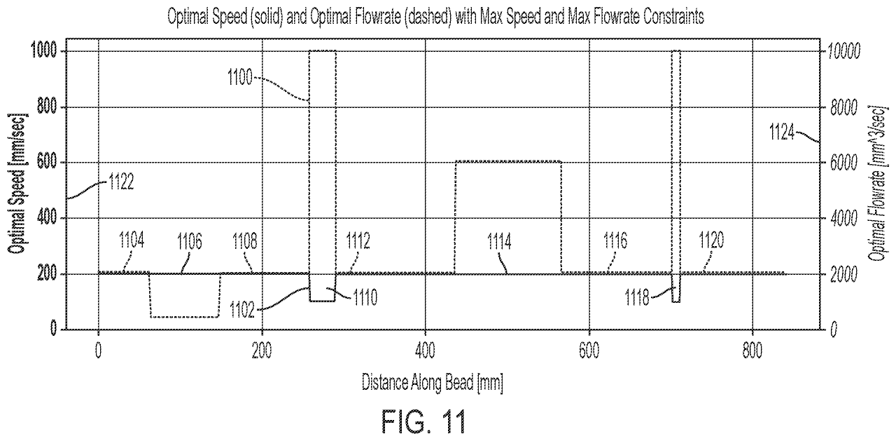

In some embodiments, the dispenser may be configurable to change the flow rate during the dispensing process, allowing different flow rates to be used while forming one bead. The controlling device 102 may calculate the optimal flow rate values of the material dispenser 116 and optimal speed for the robotic mechanism 114. These calculations are based on the physical constraints of the material dispenser 116 and robotic mechanism 114, such as the robot's maximum speed and material dispenser's maximum flow rate, as well as other constraints. These physical constraints may be included in the model of the material dispenser 116 and the model of the robotic mechanism 114. Taking again sample bead 800 of FIG. 8, a robot with a maximum speed of 200 mm/sec, and a dispenser with a maximum flow rate of 10,000 mm³/sec, the controlling device 102 may calculate the optimal flow rates 1100 (in dashed line) and speed 1102 show in FIG. 11, with the left legend 1122 showing speed and right legend 1124 showing flow rate.

The sections of FIG. 11 correspond to those of FIG. 8 as follows: 1104 corresponds to 804, 1106 corresponds to 806, 1108 to 808, 1110 corresponds to 810, 1112 corresponds to 812, 1114 corresponds to 814, 1116 corresponds to 816, 1118 corresponds to 818, and 1120 corresponds to 820.

Due to the physical constraints of the robotic mechanism 114 and material dispenser 116, such as but not limited to maximum rate of change for the dispenser flow rate and robotic mechanism speed, the robot and dispenser may not be able to exactly produce the optimal values shown in FIG. 11. These physical constraints of the robotic mechanism 114 may be included in the model of the robotic mechanism 114, and the model may be updated as the robotic mechanism 114 and material dispenser 116 dispense beads.

In some embodiments, the controlling device 102 may take into account additional physical constraints of the material dispenser 116 and robotic mechanism 114. These may be included in the model of the material dispenser 116 and model of the robotic mechanism 114, or communicated to the controlling device 102 as parameters of the dispenser mechanism and robotic mechanism 114. These parameters may be provided with the material dispenser 116 and robotic mechanism 114, for example by the manufacturer, or may be determined empirically by running test parts, or by iteratively fine-tuning the speed of the robotic mechanism 114 and material dispenser 116 flow rate while running multiple repetitions of the dispense process. The model of the robotic mechanism 114 may include factors such as, for example, the robotic mechanism 114 slowing down or speeding up during turns or corners in the material bead. It may also include how quickly the robotic mechanism 114 may change speed, for example a rate of change.

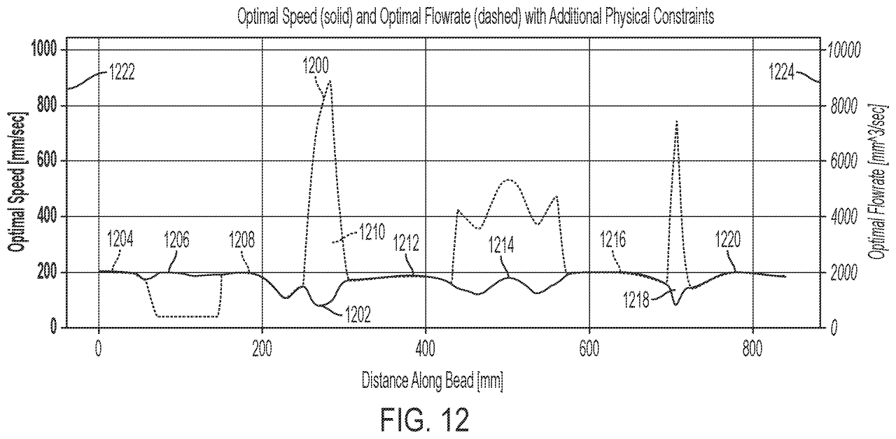

The controlling device 102 in updating the model may take into account factors such as the robot slowing down, as well as the rate at which the dispenser flow rate changes (e.g., limited or time-constant rise-time) and robotic mechanism 114 speed changes, to produce an additional optimal flow rate and robotic mechanism 114 speed values as show in FIG. 12. Taking again sample bead 800 of FIG. 8, a robot with a maximum speed of 200 mm/sec, and a dispenser with a maximum flow rate of 10,000 mm³/sec, the controlling device 102 may calculate the optimal flow rates 1200 (in dashed line) and speed 1202 show in FIG. 12, with the left legend 1222 showing speed and right legend 1224 showing flow rate. The sections of FIG. 12 correspond to those of FIG. 8 as follows: 1204 corresponds to 804, 1206 corresponds to 806, 1208 corresponds to 808, 1210 corresponds to 810, 1212 corresponds to 812, 1214 corresponds to 814, 1216 corresponds to 816, 1218 corresponds to 818, and 1220 corresponds to 820. The optimal flow rates may be sent to the dispenser in real-time intervals (e.g., every 10 milliseconds). In some embodiments, the optimal flow rates may be uploaded to the dispenser prior to dispensing the bead. The optimal flow rates may also be used to update an existing dispenser program. The speed of the robot for the individual segments may be sent to the robot in similar ways to those described with respect to fixed flow rate embodiments. For example, the controlling device 102 may generate the optimal speeds upload the speeds to the robotic mechanism 114 prior to the robotic mechanism 114 dispensing the bead. The optimal speeds may be used to update an existing program in the robotic mechanism 114 for dispensing the bead.

The controlling device 102 may send real-time speed values to the robotic mechanism 114 at regular intervals (e.g., every 10 milliseconds) during the dispensing process. The speed values may be in mm/sec or may be as a percentage of the robot's programmed speed or maximum (actual or effective) speed. The controlling device 102 may send real-time motion commands to the robotic mechanism 114 at regular intervals (e.g., every 10 milliseconds) during the dispense process. The robotic commands may be sent using open or proprietary protocols for communicating with the robot. In the example of FIG. 12, the dispensing process takes 5 seconds.

In either fixed flow rate or variable flow rate embodiments, the controlling device 102 may monitor the dispensed bead with sensors to adjust the robot speed, dispenser flow rate, or both. This may include updated the model of the robotic mechanism 114 and the model of the material dispenser. For example, if a section of the bead is thinner than desired, the controlling device 102 may decrease the robot speed or increase the flow rate. This allows the controlling device 102 to adjust as conditions in the environment of the system and the material dispenser 116 change. Such conditions may include barometric pressure, ambient temperature, viscosity of the material, and equipment wear and tear. The controlling device 102 may also send a message to a user interface, for example to the HMI, if conditions change such that the bead is out of specification.

In some embodiments, the controlling device 102 and/or the system 100 may perform the methods described herein. However, the methods described herein as performed by the controlling device 102 and/or system 100 are not meant to be limiting, and any type of software executed on a controller can perform the methods described herein without departing from the scope of this disclosure. For example, a controller, such as a processor executing software within a computing device, can perform the methods described herein.

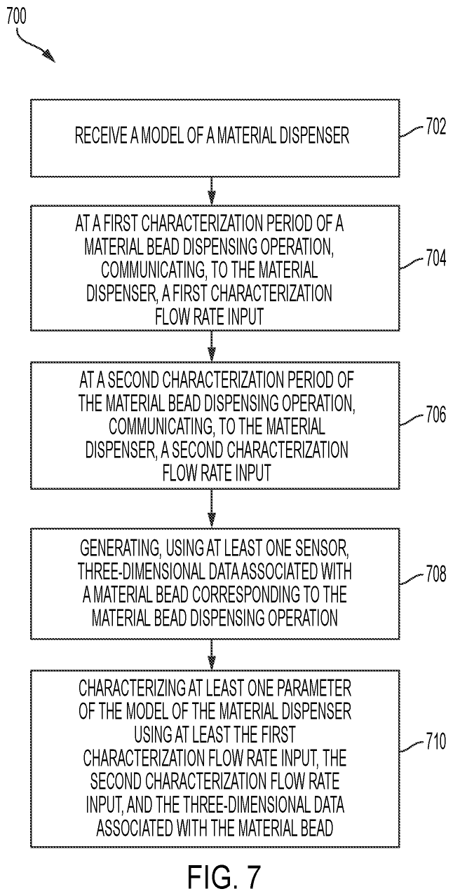

FIG. 7 is a flow diagram generally illustrating a material dispenser characterization method 700 according to the principles of the present disclosure. At 702, the method 700 receives a model of the material dispenser. For example, the controlling device 102 may receive the model 600.

At 704, the method 700, at a first characterization period of a material bead dispensing operation, communicates, to the material dispenser, a first characterization flow rate input. For example, the controlling device 102 may, at the first characterization period of the material bead dispensing operation, communicate the first characterization flow rate input to the material dispenser 116.

At 706, the method 700, at a second characterization period of the material bead dispensing operation, communicate, to the material dispenser, a second characterization flow rate input. For example, the controlling device 102 may, at the second characterization period of the material bead dispensing operation, communicate the second characterization flow rate input to the material dispenser 116.

At 708, the method 700 generates, using at least one sensor, three-dimensional data associated with a material bead corresponding to the material bead dispensing operation. For example, the controlling device 102 may generate, using the sensors 160, three-dimensional data associated with the material bead corresponding to the material bead dispensing operation.

At 710, the method 700 characterizes at least one parameter of the model of the material dispenser using at least the first characterization flow rate input, the second characterization flow rate input, and the three-dimensional data associated with the material bead. For example, the controlling device 102 may characterize the at least one parameter of the model 600 of the material dispenser 116 using at least the first characterization flow rate input, the second characterization flow rate input, and the three-dimensional data associated with the material bead.

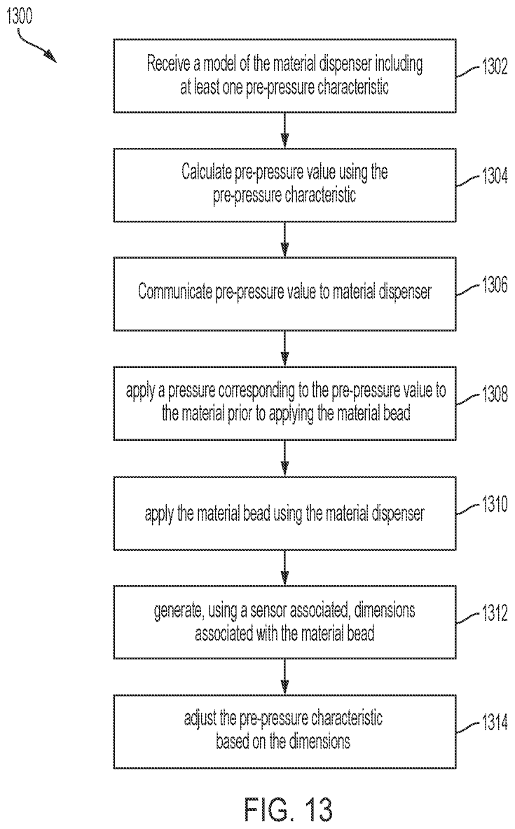

FIG. 13 is a flow diagram generally illustrating a material dispenser 116 characterization method 1300 according to the principles of the present disclosure. At 1302, the method 1300 receives a model 600 of the material dispenser 116 including a pre-pressure parameter. For example, the controlling device 102 may receive the model 600. At 1304, the method 1300 calculates, based on the model, a pre-pressure value. For example, the controlling device 102 may compute a pre-pressure value based on pre-pressure characteristics included in the model.

At 1306, the method 1300 communicates the pre-pressure value to the material dispenser 116 for use in a material bead dispensing operation. For example, the controlling device 102 may communicate the pre-pressure value to the material dispenser 116. At 1308, the method 1300 applies a pressure corresponding to the pre-pressure value to the material prior to applying the material bead. For example, a barrel of the material dispenser 116 may be pressurized to the pre-pressure value. At 1310, the method 1300 applies the material bead using the material dispenser 116. For example, the material dispenser 116 may apply a bead by opening a valve of the material dispenser to apply a material bead to a component.

At 1312, the method generates, using at least one sensor, dimensions associated with a material bead corresponding to the material bead dispensing operation. For example, the controlling device 102 may generate, using the sensors 160, dimensions, which may include three-dimensional data, associated with the material bead corresponding to the material bead dispensing operation. At 1314, the method adjusts the pre-pressure characteristics based on the dimensions. For example, the controlling device 102 may update the model, including the pre-pressure characteristics, based on a bead corresponding to the material bead dispensing operation.

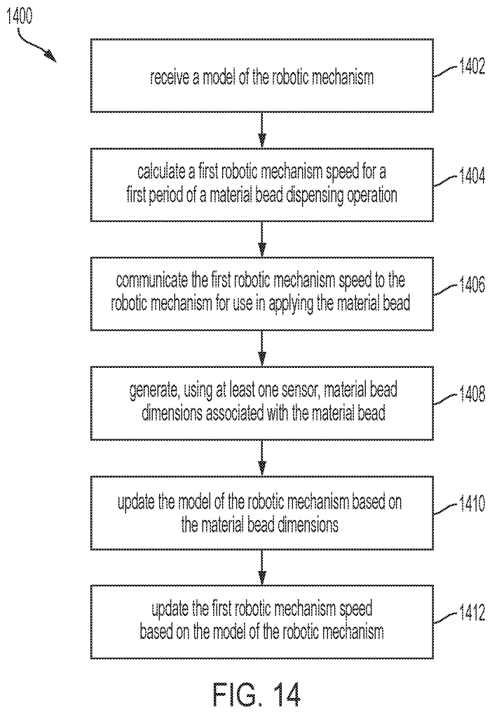

FIG. 14 is a flow diagram generally illustrating a method 1400 for characterizing a robotic mechanism 114 for use with a material dispenser 116. At 1402, the method 1400 receives a model of the robotic mechanism 114 and a model of the material dispenser 116. For example, the controlling device 102 may receive the model 600, which may include both a model of the material dispenser 116 and a model of the robotic mechanism 114. The controlling device 102 may also receive the models separately.

At 1404, the method 1400, based on the model of the robotic mechanism 114, calculates a first robotic mechanism 114 speed for a first period of a material bead dispensing operation. For example, controlling device 102 may compute a first robotic mechanism 114 speed based on model 600 or based on a model of the robotic mechanism 114. At 1406, the method 1400 communicates the first robotic mechanism speed to the robotic mechanism 114 for use in applying the material bead. For example, the controlling device 102 may communicate a speed parameter to the robotic mechanism 114.

At 1408, the method 1400 generates, using at least one sensor, material bead dimensions associated with the material bead. For example, the controlling device 102 may generate, using the sensors 160, three-dimensional data associated with the material bead corresponding to the material bead dispensing operation. At 1410, the method 1400 updates the model of the robotic mechanism 114 based on the material bead dimensions. For example, the controlling device 102 may update model 600 or a model associated with the robotic mechanism 114.

At 1412, the method 1400 updates the first robotic mechanism 114 speed based on the model of the robotic mechanism 114. For example, controlling device 102 may update the robotic mechanism 114 speed, increasing the speed if bead dimensions were too large or decreasing the speed if the bead dimensions were too small. The controlling device 102 may also update the robotic mechanism 114 speed based on other parameters besides bead dimension.

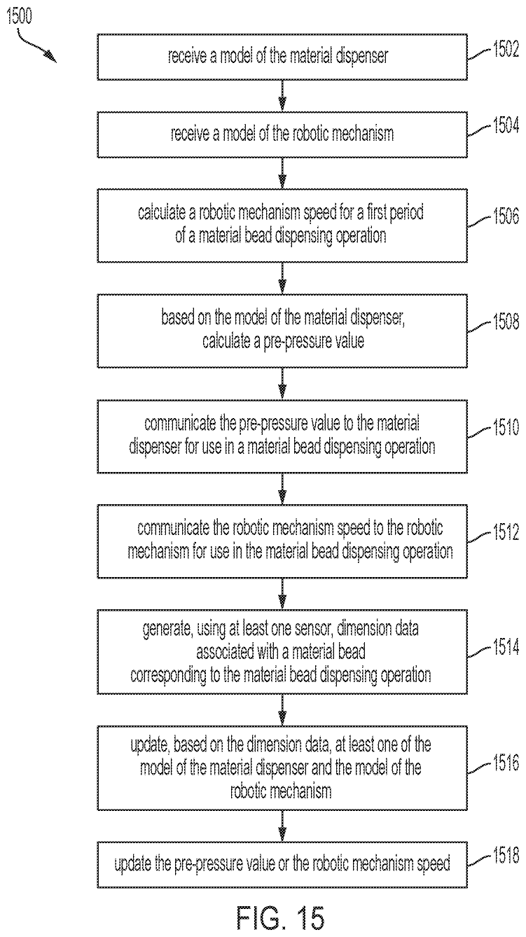

FIG. 15 is a flow diagram generally illustrating a method 1500 for controlling a material dispenser 116 and a robotic mechanism 114 for use with the material dispenser. At 1502, the method 1500 receives a model of the material dispenser. For example, the controlling device 102 may receive model 600. At 1504, the model receives a model of the robotic mechanism 114. For example, the controlling device 102 may receive a model of the robotic mechanism 114 or may receive model 600. At 1506, the method 1500 calculates a robotic mechanism 114 speed for a first period of a material bead dispensing operation. For example, controlling device 102 may calculate a robotic mechanism 114 speed based on the model of the robotic mechanism 114. The controlling device 102 may also use the model of the material dispenser. At 1508, based on the model of the material dispenser, the method 1500 calculates a pre-pressure value. For example, controlling device 102 may calculate a pre-pressure value to pressurize a material in a material dispenser 116 to prior to dispensing a material bead based on model 600.

At 1510, the method 1500 may communicate the pre-pressure value to the material dispenser 116 for use in a material bead dispensing operation. For example, the controlling device 102 may communicate a pre-pressure value to pressurize a material in a material dispenser 116 to prior to dispensing a material bead. At 1512, the method 1500 may communicate the robotic mechanism 114 speed to the robotic mechanism 114 for use in the material bead dispensing operation. For example, the robotic mechanism 114 102 may communicate the robotic mechanism speed to robotic mechanism 114.

At 1514, the method 1500 may generate, using at least one sensor, dimension data associated with a material bead corresponding to the material bead dispensing operation. For example, the controlling device 102 may generate, using the sensors 160, dimensions, which may include three-dimensional data, associated with the material bead corresponding to the material bead dispensing operation. At 1516, the method 1500 updates, based on the dimension data, at least one of the model of the material dispenser and the model of the robotic mechanism 114. For example, the controlling device 102 may update model 600 or a model associated with the robotic mechanism 114.

At 1518, the method 1500 may update the pre-pressure value or the robotic mechanism speed. For example, the controlling device 102 may update at least one of the pre-pressure value based on the model of the dispenser and the robotic mechanism speed based on the model of the robotic mechanism 114.

Clause 1. A method for characterizing a material dispenser, the method comprising: receiving a model of the material dispenser; at a first characterization period of a material bead dispensing operation, communicating, to the material dispenser, a first characterization flow rate input; at a second characterization period of the material bead dispensing operation, communicating, to the material dispenser, a second characterization flow rate input; generating, using at least one sensor, three-dimensional data associated with a material bead corresponding to the material bead dispensing operation; and characterizing at least one parameter of the model of the material dispenser using at least the first characterization flow rate input, the second characterization flow rate input, and the three-dimensional data associated with the material bead.

Clause 2. The method of clause 1 or any other clauses described herein, wherein the first characterization flow rate input and the second characterization flow rate input correspond to a step function.

Clause 3. The method of clause 1 or any other clauses described herein, wherein the first characterization flow rate input and second characterization flow rate input include arbitrary values.

Clause 4. The method of clause 1 or any other clauses described herein, wherein the three-dimensional data corresponds to at least one portion of the material bead comprising a predefined pattern.

Clause 5. The method of clause 4 or any other clauses described herein, wherein the predefined pattern includes a straight line.

Clause 6. The method of clause 1 or any other clauses described herein, wherein characterizing the at least one parameter of the model of the material dispenser includes: revising the model of the material dispenser by updating the at least one parameter of the model of the material dispenser; and storing the revised model of the material dispenser.

Clause 7. The method of clause 6 or any other clauses described herein, further comprising generating, in response to receiving a material dispense command, a material dispense flow rate input according to the revised model of the material dispenser.

Clause 8. The method of clause 7 or any other clauses described herein, further comprising generating, using the at least one sensor, three-dimensional data associated with at least one other material bead corresponding to another material bead dispensing operation associated with the material dispense flow rate input.

Clause 9. The method of clause 1 or any other clauses described herein, iteratively revising the model of the material dispenser using, at least, three-dimensional data, generated using the at least one sensor, associated with a plurality of other material beads corresponding to other material bead dispensing operations.

Clause 10. The method of clause 1 or any other clauses described herein, the at least one sensor includes a laser.

Clause 11. The method of clause 1 or any other clauses described herein, wherein the at least one sensor includes an image capturing device.

Clause 12. An apparatus for characterizing a material dispenser, the apparatus comprising: a processor; and a memory including instructions that, when executed by the processor, cause the processor to: receive a model of the material dispenser; at a first characterization period of a material bead dispensing operation, communicate, to the material dispenser, a first characterization flow rate input; at a second characterization period of the material bead dispensing operation, communicate, to the material dispenser, a second characterization flow rate input; generate, using at least one sensor, three-dimensional data associated with a material bead corresponding to the material bead dispensing operation; and characterize at least one parameter of the model of the material dispenser using at least the first characterization flow rate input, the second characterization flow rate input, and the three-dimensional data associated with the material bead.

Clause 13. The apparatus of clause 12 or any other clauses described herein, wherein the first characterization flow rate input and the second characterization flow rate input correspond to a step function.

Clause 14. The apparatus of clause 12 or any other clauses described herein, wherein the first characterization flow rate input and second characterization flow rate input include arbitrary values.

Clause 15. The apparatus of clause 12 or any other clauses described herein, wherein the three-dimensional data corresponds to at least one portion of the material bead comprising a predefined pattern.

Clause 16. The apparatus of clause 15 or any other clauses described herein, wherein the predefined pattern includes a straight line.

Clause 17. A system comprising: a material dispenser configured to dispense a material bead; and a controlling mechanism configured to: receive a model of the material dispenser; at a first characterization period of a material bead dispensing operation, communicate, to the material dispenser, a first characterization flow rate input; at a second characterization period of the material bead dispensing operation, communicate, to the material dispenser, a second characterization flow rate input; generate, using a plurality of sensors, three-dimensional data associated with a material bead corresponding to the material bead dispensing operation; and characterize at least one parameter of the model of the material dispenser using at least the first characterization flow rate input, the second characterization flow rate input, and the three-dimensional data associated with the material bead.

Clause 18. The system of clause 17 or any other clauses described herein, wherein the plurality of sensors includes at least one laser.

Clause 19. The system of clause 17 or any other clauses described herein, wherein the plurality of sensors includes at least one image capturing device.

Clause 20. The system of clause 17 or any other clauses described herein, wherein the plurality of sensors includes at least one laser and two or more image capturing devices.

Clause 21. A method for characterizing a material dispenser that dispenses a material in a material bead, the method comprising: receiving a model including at least one pre-pressure characteristic associated with the material dispenser; calculating, using the pre-pressure characteristic, a pre-pressure value; communicating the pre-pressure value to the material dispenser; at the material dispenser, applying a pressure corresponding to the pre-pressure value to the material prior to applying the material bead; applying the material bead using the material dispenser; generating, using data received from at least one sensor associated with the material bead dispenser, dimensions associated with the material bead; and adjusting the pre-pressure characteristic based on the dimensions.

Clause 22. The method of clause 21 or any other clauses described herein, wherein the dimensions include at least dimensions of an initial portion of the material bead.

Clause 23. The method of clause 21 or any other clauses described herein, wherein the pre-pressure characteristic is generated using data, captured by the at least one sensor, associated with at least one material dispensing test operation performed by the material dispenser.

Clause 24. The method of clause 21 or any other clauses described herein, wherein the model includes at least one of at least one ambient temperature measurement of an environment associated with the material dispenser, at least one barometric pressure measurement of the environment associated with the material dispenser, at least one humidity measurement of the environment associated with the material dispenser, and at least one viscosity measurement of the material dispensed by the material dispenser.

Clause 25. The method of clause 21 or any other clauses described herein, wherein the sensor includes at least one of a laser and an image capturing device.

Clause 26. The method of clause 21 or any other clauses described herein, further comprising: iteratively adjusting at least one aspect of the model using other material bead dimensions associated with other material beads corresponding to other material bead dispensing operations, wherein the other material bead dimensions are generated using corresponding data received from the at least one sensor.

Clause 27. A system comprising: a robotic mechanism for use with a material dispenser configured to dispense a material in a material bead; and a controlling device configured to: receive a model of the robotic mechanism; based on the model of the robotic mechanism, calculate a first robotic mechanism speed for a first period of a material bead dispensing operation; communicate the first robotic mechanism speed to the robotic mechanism for use in applying the material bead; generate, using at least one sensor, material bead dimensions associated with the material bead; update the model of the robotic mechanism based on the material bead dimensions; and update the first robotic mechanism speed based on the model of the robotic mechanism.

Clause 28. The system of clause 27 or any other clauses described herein, wherein the model of the robotic mechanism is generated using data, captured by the at least one sensor, associated with at least one material dispensing operation performed by the material dispenser.

Clause 29. The system of clause 27 or any other clauses described herein, wherein the controlling device further calculates a second robotic mechanism speed for a second period of the material bead dispensing operation.

Clause 30. The system of clause 27 or any other clauses described herein, further comprising: iteratively revising the model of the robotic mechanism using a plurality of material bead dimensions, generated using the at least one sensor, associated with a plurality of other material beads corresponding to other material bead dispensing operations.

Clause 31. The system of clause 27 or any other clauses described herein, wherein the controlling device receives a model of the material dispenser, the controlling device further configured to: based on the model of the material dispenser, calculate a first characterization of the flow rate input; communicate the first characterization of the flow rate input to the material dispenser; update the model of the material dispenser based on the material bead dimensions; and update the first characterization of flow rate input based on the model of the material dispenser.

Clause 32. The system of clause 27 or any other clauses described herein, wherein the model of the robotic mechanism includes a maximum speed of the robotic mechanism.

Clause 33. The system of clause 27 or any other clauses described herein, wherein the model of the robotic mechanism includes a maximum rate of change of speed of the robotic mechanism.

Clause 34. An apparatus for controlling a material dispenser and a robotic mechanism for use with the material dispenser, the apparatus comprising: a processor; and a memory including instructions that, when executed by the processor, cause the processor to: receive a model of the material dispenser; receive a model of the robotic mechanism; based on the model of the robotic mechanism, calculate a robotic mechanism speed for a first period of a material bead dispensing operation; based on the model of the material dispenser, calculate a pre-pressure value; communicating the pre-pressure value to the material dispenser for use in a material bead dispensing operation; communicating the robotic mechanism speed to the robotic mechanism for use in the material bead dispensing operation; generate, using at least one sensor, dimension data associated with a material bead corresponding to the material bead dispensing operation; updating, based on the dimension data, at least one of the model of the material dispenser and the model of the robotic mechanism; and updating at least one of the pre-pressure value based on the model of the dispenser and the robotic mechanism speed based on the model of the robotic mechanism.

Clause 35. The apparatus of clause 34 or any other clauses described herein, wherein the model of the material dispenser and the model of the robotic mechanism are iteratively updated based on a plurality of parameters associated with a plurality of other material beads corresponding to other bead dispensing operations.

Clause 36. The apparatus of clause 34 or any other clauses described herein, wherein the model of the robotic mechanism includes a maximum speed of the robotic mechanism.

Clause 37. The apparatus of clause 34 or any other clauses described herein, wherein the model of the robotic mechanism includes a maximum rate of change of speed of the robotic mechanism.

Clause 38. The apparatus of clause 34 or any other clauses described herein, wherein the model of the material dispenser and the model of the robotic mechanism are generated using data, captured by the at least one sensor, associated with at least one material dispensing test operation.

Clause 39. The apparatus of clause 34 or any other clauses described herein, wherein the sensor includes at least one of a laser and an image capturing device.

Clause 40. The apparatus of clause 34 or any other clauses described herein, wherein the apparatus iteratively adjusts the model of the material dispenser and the model of the a robotic mechanism using other material bead dimensions associated with other material beads corresponding to other material bead dispensing operations, wherein the other material bead dimensions are generated using corresponding data received from the at least one sensor.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation to encompass all such modifications and equivalent structure as is permitted under the law.

What is claimed is:

1. A method for characterizing a material dispenser that dispenses a material in a material bead, the method comprising:
receiving a model including at least one pre-pressure characteristic associated with the material dispenser;
calculating, using the pre-pressure characteristic, a pre-pressure value;
communicating the pre-pressure value to the material dispenser;
at the material dispenser, applying a pressure corresponding to the pre-pressure value to the material prior to applying the material bead;
applying the material bead using the material dispenser;
generating, using data received from at least one sensor associated with the material bead dispenser, dimensions associated with the material bead; and
adjusting the pre-pressure characteristic based on the dimensions.

2. The method of claim 1, wherein the dimensions include at least dimensions of an initial portion of the material bead.

3. The method of claim 1, wherein the pre-pressure characteristic is generated using data, captured by the at least one sensor, associated with at least one material dispensing test operation performed by the material dispenser.

4. The method of claim 1, wherein the model includes at least one of at least one ambient temperature measurement of an environment associated with the material dispenser, at least one barometric pressure measurement of the environment associated with the material dispenser, at least one humidity measurement of the environment associated with the material dispenser, and at least one viscosity measurement of the material dispensed by the material dispenser.

5. The method of claim 1, wherein the sensor includes at least one of a laser and an image capturing device.

6. The method of claim 1, further comprising:
iteratively adjusting at least one aspect of the model using other material bead dimensions associated with other material beads corresponding to other material bead dispensing operations, wherein the other material bead dimensions are generated using corresponding data received from the at least one sensor.

7. A system comprising:
a robotic mechanism for use with a material dispenser configured to dispense a material in a material bead; and
a controlling device configured to:
receive a model of the robotic mechanism;
based on the model of the robotic mechanism, calculate a first robotic mechanism speed for a first period of a material bead dispensing operation;
communicate the first robotic mechanism speed to the robotic mechanism for use in applying the material bead;
generate, using at least one sensor, material bead dimensions associated with the material bead;
update the model of the robotic mechanism based on the material bead dimensions; and
update the first robotic mechanism speed based on the model of the robotic mechanism.

8. The system of claim 7, wherein the model of the robotic mechanism is generated using data, captured by the at least one sensor, associated with at least one material dispensing operation performed by the material dispenser.

9. The system of claim 7, wherein the controlling device further calculates a second robotic mechanism speed for a second period of the material bead dispensing operation.

10. The system of claim 7, further comprising:
iteratively revising the model of the robotic mechanism using a plurality of material bead dimensions, generated using the at least one sensor, associated with a plurality of other material beads corresponding to other material bead dispensing operations.

11. The system of claim 7, wherein the controlling device receives a model of the material dispenser, the controlling device further configured to:
based on the model of the material dispenser, calculate a first characterization of the flow rate input;
communicate the first characterization of the flow rate input to the material dispenser;
update the model of the material dispenser based on the material bead dimensions; and
update the first characterization of flow rate input based on the model of the material dispenser.

12. The system of claim 7, wherein the model of the robotic mechanism includes a maximum speed of the robotic mechanism.

13. The system of claim 7, wherein the model of the robotic mechanism includes a maximum rate of change of speed of the robotic mechanism.

14. An apparatus for controlling a material dispenser and a robotic mechanism for use with the material dispenser, the apparatus comprising:
a processor; and
a memory including instructions that, when executed by the processor, cause the processor to:
receive a model of the material dispenser;
receive a model of the robotic mechanism;
based on the model of the robotic mechanism, calculate a robotic mechanism speed for a first period of a material bead dispensing operation;
based on the model of the material dispenser, calculate a pre-pressure value;
communicating the pre-pressure value to the material dispenser for use in a material bead dispensing operation;
communicating the robotic mechanism speed to the robotic mechanism for use in the material bead dispensing operation;
generate, using at least one sensor, dimension data associated with a material bead corresponding to the material bead dispensing operation;
updating, based on the dimension data, at least one of the model of the material dispenser and the model of the robotic mechanism; and
updating at least one of the pre-pressure value based on the model of the dispenser and the robotic mechanism speed based on the model of the robotic mechanism.

15. The apparatus of claim 14, wherein the model of the material dispenser and the model of the robotic mechanism are iteratively updated based on a plurality of parameters associated with a plurality of other material beads corresponding to other bead dispensing operations.

16. The apparatus of claim 14, wherein the model of the robotic mechanism includes a maximum speed of the robotic mechanism.

17. The apparatus of claim 14, wherein the model of the robotic mechanism includes a maximum rate of change of speed of the robotic mechanism.

18. The apparatus of claim 14, wherein the model of the material dispenser and the model of the robotic mechanism are generated using data, captured by the at least one sensor, associated with at least one material dispensing test operation.

19. The apparatus of claim 14, wherein the sensor includes at least one of a laser and an image capturing device.

20. The apparatus of claim 14, wherein the apparatus iteratively adjusts the model of the material dispenser and the model of the a robotic mechanism using other material bead dimensions associated with other material beads corresponding to other material bead dispensing operations, wherein the other material bead dimensions are generated using corresponding data received from the at least one sensor.
